(19) United States
(12) Patent Application Publication
(10) Pub. No.: US 2016/0298543 A1
(43) Pub. Date: Oct. 13, 2016

(54) LUBRICANT CIRCULATION SYSTEM AND METHOD OF CIRCULATING LUBRICANT IN A GAS TURBINE ENGINE

(71) Applicant: United Technologies Corporation, Farmington, CT (US)

(72) Inventors: Gabriel L. Suciu, Glastonbury, CT (US); William G. Sheridan, Southington, CT (US)

(21) Appl. No.: 14/685,240

(22) Filed: Apr. 13, 2015

(51) Int. Cl. F02C 7/14; F01D 25/20; F02C 7/18

(52) U.S. Cl. CPC F02C 7/14; F02C 7/18; F01D 25/20

(57) ABSTRACT

A lubricant circulation system and method of circulating lubricant in a gas turbine engine are disclosed. The lubricant circulation system includes a nose cone having an aperture communicating air to an interior space of the nose cone, a heat exchanger disposed in the interior space, and a lubricant circulation pathway contained within a forward portion of the gas turbine engine and configured to circulate lubricant through the heat exchanger.

### TECHNICAL FIELD OF THE DISCLOSED EMBODIMENTS

The present disclosure is generally related to turbine engines, in particular to a lubricant circulating system and a method of circulating lubricant in a gas turbine engine.

### BACKGROUND OF THE DISCLOSED EMBODIMENTS

Gas turbine engines include bearing assemblies to support the rotating shafts of the engine. During operation, the bearing assemblies experience high thermal loads that may be controlled with a thermal management system. A thermal management system utilizes a heat exchanger to cool fluids such as oil flowing to and from bearing assemblies or other engine components. A thermal management system enhances durability and provides efficient operation of bearing assemblies and other engine components. However, thermal management systems often include a complex network of airflow circulation pathways and fluid lines to effectively cool the high temperature fluid. In some gas turbine engines, incorporation of a thermal management system is challenging.

Therefore, a need exists in the art for a thermal management system for a gas turbine engine having enhanced efficiency and applicability.

### SUMMARY OF THE DISCLOSED EMBODIMENTS

In an embodiment, a lubricant circulation system for a gas turbine engine is disclosed comprising a nose cone having an aperture communicating air to an interior space of the nose cone, a heat exchanger disposed in the interior space, and a lubricant circulation pathway contained within a forward portion of the gas turbine engine and configured to circulate lubricant through the heat exchanger.

In a further embodiment of the above, the system further comprises a front bearing compartment at the forward portion of the gas turbine engine, wherein the lubricant circulation pathway is configured to circulate lubricant between the front bearing compartment and the heat exchanger. In a further embodiment of any of the above, the system further comprises a lubricant pump in the lubricant circulation pathway. In a further embodiment of any of the above, the system further comprises a lubricant filter in the lubricant circulation pathway. In a further embodiment of any of the above, the system further comprises an air pump at least partially disposed within the nose cone and configured to communicate air through the heat exchanger. In a further embodiment of any of the above, the air pump is further configured to communicate air around the forward portion of the gas turbine engine. In a further embodiment of any of the above, the air pump is driven by a low shaft to communicate air through the aperture. In a further embodiment of any of the above, the air pump is driven through a planetary gear box coupled to the low shaft. In a further embodiment of any of the above, the system further comprises a lubricant pump in the lubricant circulation pathway, wherein the lubricant pump is driven by a rotation of the air pump.

In another embodiment, a method of circulating lubricant in a gas turbine engine is disclosed comprising providing a nose cone having an aperture and an interior space, providing a heat exchanger in the interior space, providing a lubricant reservoir within a forward portion of the gas turbine engine, communicating air to the interior space of the nose cone through the aperture, and circulating lubricant through a lubricant circulation pathway between the heat exchanger and the lubricant reservoir.

In a further embodiment of any of the above, the method further comprises providing a front bearing compartment at the forward portion of the gas turbine engine, and circulating lubricant in the lubricant circulation pathway between the front bearing compartment and the heat exchanger. In a further embodiment of any of the above, the method further comprises providing a lubricant pump in the lubricant circulation pathway, and pumping lubricant through the lubricant circulation pathway with the lubricant pump. In a further embodiment of any of the above, the method further comprises providing a low shaft in the gas turbine engine, and driving the lubricant pump with the low shaft. In a further embodiment of any of the above, the method further comprises providing a lubricant filter in the lubricant circulation pathway, and circulating lubricant through the lubricant filter. In a further embodiment of any of the above, the method further comprises providing a breather vent at the forward portion of the gas turbine engine, and venting air from the forward portion out of the gas turbine engine. In a further embodiment of any of the above, the method further comprises providing an air pump at least partially disposed within the nose cone, and pumping air through the heat exchanger with the air pump. In a further embodiment of any of the above, the method further comprises pumping air around the forward portion of the gas turbine engine with the air pump. In a further embodiment of any of the above, the method further comprises driving the air pump with an engine shaft to communicate air through the aperture. In a further embodiment of any of the above, the method further comprises driving the air pump through a planetary gear box coupled to the engine shaft. In a further embodiment of any of the above, the method further comprises providing a lubricant pump in the lubricant circulation pathway, and driving the lubricant pump with the air pump.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a sectional view of one example of a gas turbine engine in which the presently disclosed embodiments may be used;

FIG. 2 is a partial cross sectional view of a gas turbine engine in one embodiment;

FIG. 3 is a partial cross sectional view of a gas turbine engine in one embodiment;

FIG. 4 is a partial cross sectional view of a gas turbine engine in one embodiment;

FIG. 5 is a partial cross sectional view of a gas turbine engine in one embodiment; and

FIG. 6 illustrates a method of circulating lubricant in a gas turbine engine in one embodiment.

### DETAILED DESCRIPTION OF THE DISCLOSED EMBODIMENTS

For the purposes of promoting an understanding of the principles of the disclosure, reference will now be made to certain embodiments and specific language will be used to describe the same. It will nevertheless be understood that no limitation of the scope of the disclosure is thereby intended, and alterations and modifications in the illustrated device, and further applications of the principles of the disclosure as illustrated therein are herein contemplated as would normally occur to one skilled in the art to which the disclosure relates.

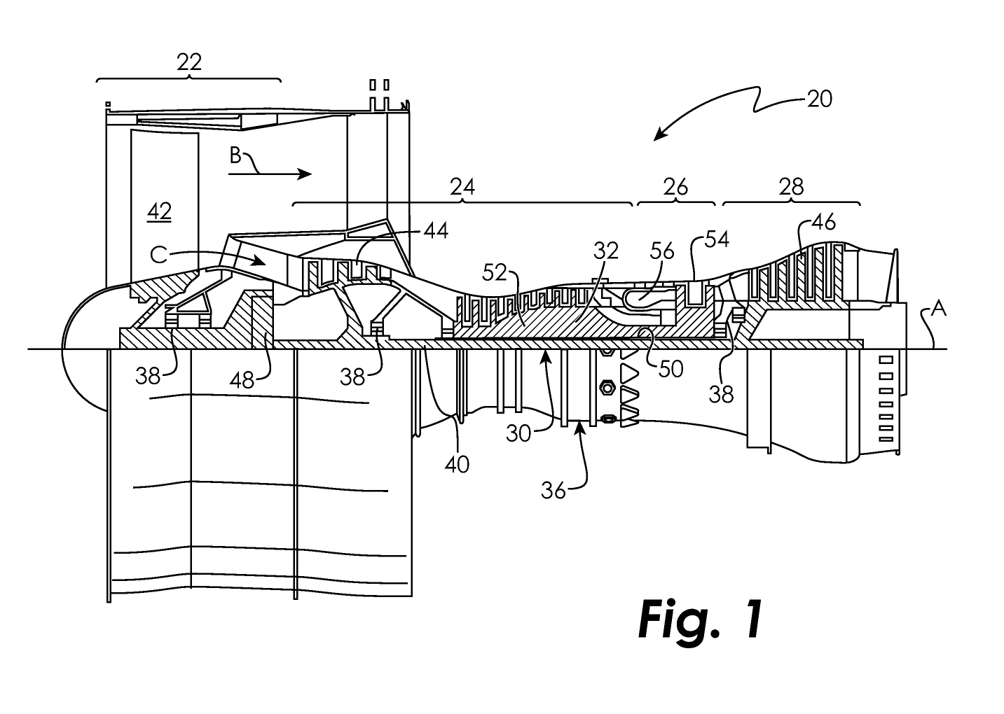

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (“TSFC”)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

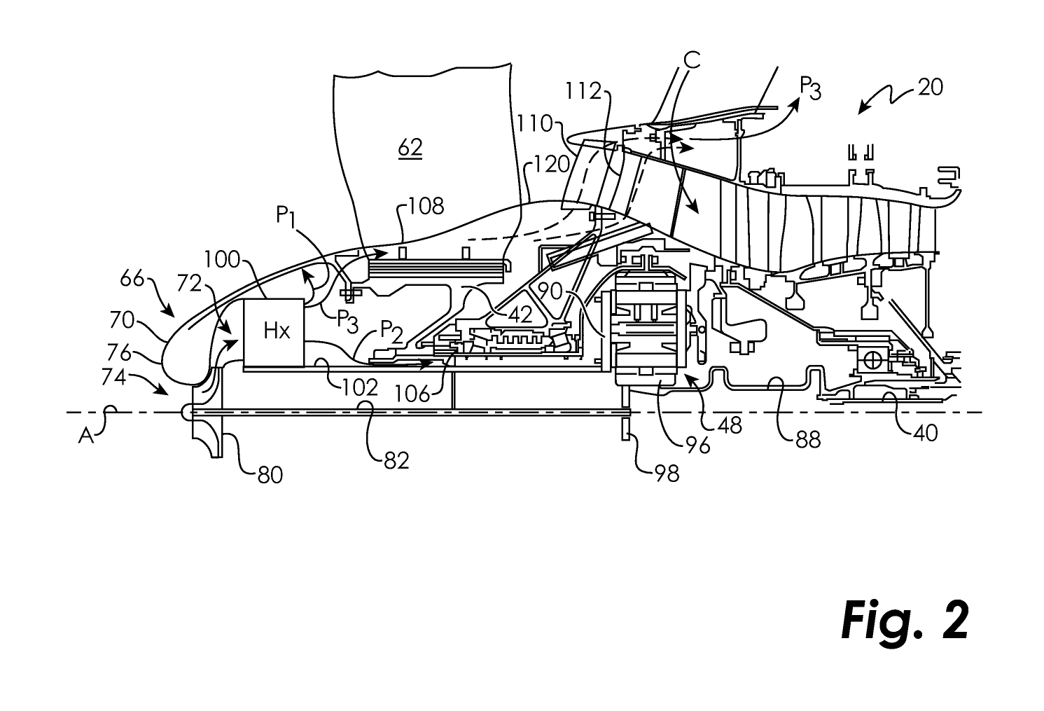

Referring now to FIG. 2, the fan rotor 42 of the gas turbine engine 20 includes a plurality of fan blades 62 extending radially from the axis A. The example gas turbine engine 20 also includes a nose cone 66. In this example, the nose cone 66 extends axially forward from the fan blades 62. This nose cone 66 is sometimes referred to as a spinner.

The nose cone 66, in this example, establishes the forwardmost portion of the gas turbine engine 20. The nose cone 66 directs and streamlines flow entering the gas turbine engine 20. An outer surface 70 of the nose cone 66 establishes a portion of a radially inner boundary of a flowpath for flow entering the engine 20. The nose cone 66 may include one piece or several individual pieces.

The nose cone 66 has an interior 72. The nose cone 66 provides an aperture 74 that communicates flow to the interior 72. The aperture 74 may be positioned at a front 76 of the nose cone 66 as shown, or in some other position aft the front 76 of the nose cone 66. The example aperture 74 and the nose cone 66 are coaxially aligned at the axis A. Other alignments of the aperture 74 are possible. A line-of-site blockage structure may be incorporated to protect the system from birdstrike damage.

In this example, a pump, such as an impeller 80, is used to increase the amount of air entering the interior. The impeller 80 is positioned at least partially within the interior 72 of the nose cone 66. The impeller 80 is driven by rotation during operation. Other example pumps may include an axial fan.

Notably, some examples may not utilize the impeller 80 or any other pump. In such examples, air enters the interior 72 through the aperture 74 due to forward movement of the engine 20. As appreciated, designs incorporating pumps typically move more air to the interior 72 than designs that do not incorporate any pumps. Air can enter the interior 72 through aperture 74 when the exit pressure at the bypass duct inner diameter discharge location can be suppressed below that of the inlet to the nose cone 66. This can occur when the engine 20 is not moving forward, but still turning, like at ground idle.

During operation, the example impeller 80 is rotated by a shaft 82, which is rotated by a shaft 88. The example shaft 88 is a flex coupling shaft. The shaft 88 is driven by the inner shaft 40 of the low-speed spool 30 (FIG. 1). Rotating the shaft 88 rotates a sun gear 96 of the geared architecture 48, which then rotates a gear 98 to rotate the shaft 82.

The example engine 20 includes a heat exchanger 100 positioned near the nose cone 66. In this example, at least a portion of the heat exchanger 100 is forward of the fan blades 62. Air that has entered the interior 72 through the aperture 74 is moved through the heat exchanger 100 to provide a cold side fluid.

The example heat exchanger 100 is a fin and tube type heat exchanger 100, although other type of heat exchangers may also be used. The heat exchanger 100 is annular and distributed about the axis A. In another example, several separate heat exchangers are distributed about the axis A. A support 102 extending axially from a stationary carrier 90 of the geared architecture 48 supports the heat exchanger 100 in this example. The support 102 may also support conduits (not shown) carrying lubricant to the heat exchanger 100.

Air that has entered the interior 72 of the nose cone 66 is pressurized relative to the air outside the nose cone 66. In one example, the difference in pressure between the air within the interior 72 of the nose cone 66 and the air outside the nose cone 66 ranges from 0.5 to 10 psi (3.45 kPa to 68.95 kPa).

Air that has entered the interior 72 of the nose cone 66 is raised to a higher temperature relative to the air outside the nose cone 66. In one example, the difference in temperature between the air within the interior 72 of the nose cone 66 and the air outside of the nose cone 66 ranges from 100° F. to 200° F. (37.78° C. to 93.33° C.).

Lubricant, such as oil from the engine 20, provides the warm side fluid for the heat exchanger 100. Air that has entered the interior 72 is moved through the heat exchanger 100 to remove thermal energy from the lubricant.

The lubricant may be a mixture of lubricant from several areas of the gas turbine engine 20, or may be lubricant from a subset of a lubrication system of the engine 20, such as a fan drive gear system lubrication system. Although the air that has entered the interior 72 is increased in temperature relative to the air outside the nose cone 66, the air that has entered the interior 72 is still significantly cooler than the lubricant within the heat exchanger 100 and therefore can still remove heat from it.

In this example, the heat exchanger 100 is configured to rejection at least 2,900 BTU/min at idle and 5,000 BTU/min and take-off.

Some of the air that has moved through the heat exchanger 100 moves along path P1 and contacts an interior facing side of the nose cone 66. This air adds thermal energy to the nose cone 66, which inhibits ice formation. As appreciated, air moving along path P1 includes more thermal energy that the air moving into the heat exchanger 100 because air that has moved through the heat exchanger 100 has absorbed thermal energy from the lubricant moving through the heat exchanger 100.

Some of the air that has moved through the heat exchanger 100 moves along path P2 and buffers a carbon seal 106 within bearings 38 of the gas turbine engine 20. The carbon seal 106 is a forward carbon seal of the front bearing compartment of the engine 20 in this particular case. The seal 106, in this example, is biased axially rearward by the air.

Most, if not all, of the air that has moved through the heat exchanger 100 eventually moves along path P3. A portion of the path P3 extends radially inward the fan blade platform 108. If additional flow area is need to permit the required flow rate, additional apertures may be included through the Fan Blade Hub Web, which is the same part as the fan rotor 42 in this example, just at a radially inboard. The path P3 also extends through an inlet guide vane 110 and a front center body strut 112. The inlet guide vane 110 and the front center body 112 include internal passages and extend radially across the core flowpath C of the engine 20. The path P3 terminates at the bypass flowpath B of the gas turbine engine 20 behind the FEGV (fan exit guide vanes). Thus, air that has entered the interior 72 through the aperture 74 is eventually expelled into the bypass flowpath B at an axial location having a static pressure that is low enough to enable sufficient flow through the heat exchanger 100.

In addition to the nose cone 66, the air that has moved through the heat exchanger 100 also adds thermal energy to inhibit ice formation on other structures, such as the fan blade platform 108, the inlet guide vane 110, and the front center body struts 112.

In this example, a seal structure 120 seals the interface between the fan rotor 42 and a stationary structure of the gas turbine engine 20. The seal structure 120 limits flow escaping from the path P3, or interior 72, to a position directly aft the fan blade 62. Such leakage into this area may undesirably introduce turbulence to the flow entering the core flowpath C of the gas turbine engine 20.

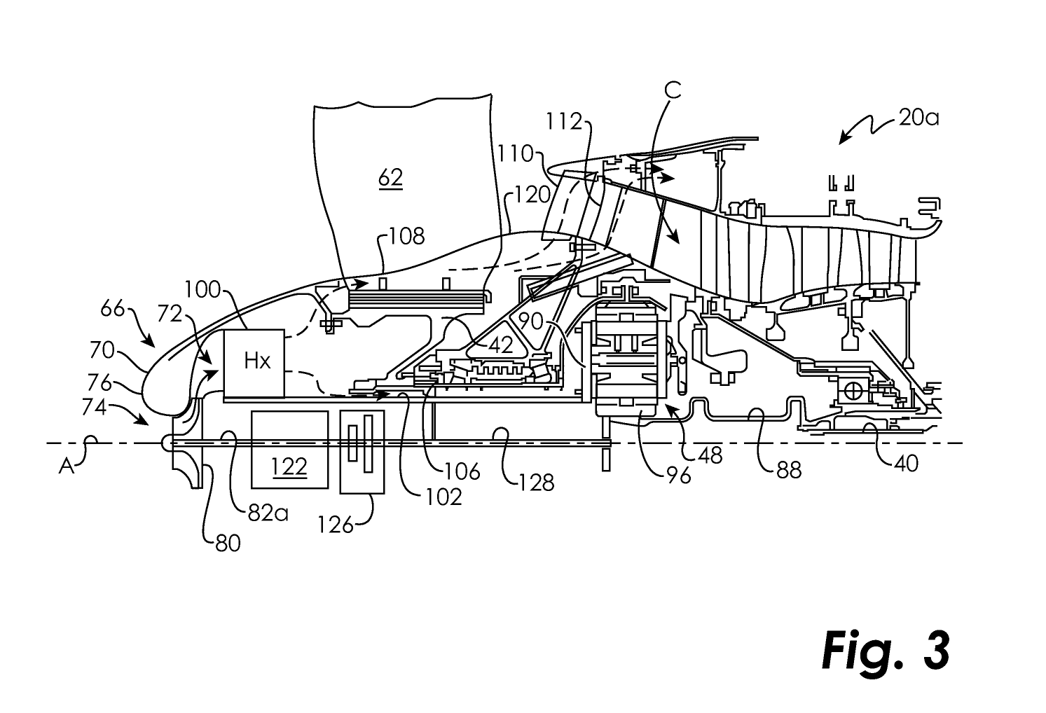

Referring to FIG. 3, in another example engine 20a, the impeller 80 is selectively driven by an electric motor 122, which allows relatively infinite adjustments of the rotational speed of the impeller 80. The motor 122 may be used to rotate the impeller 80 when the engine 20 is on the ground, at idle, or at the top of descent. When the motor 122 is not in use, the impeller 80 may be driven using the shaft 88.

In this example, a clutch 126 is moved between an engaged position and a disengaged position to selectively drive the impeller 80 using the electric motor 122 or using the shaft 88. The clutch 126 is an Air Turbine Starter (ATS)-type ratchet clutch in this example.

In the engaged position, the clutch 126 couples together the shaft 128 to a shaft 82a such that rotation of the shaft 128 rotates the shaft 82a. The shaft 82a is directly connected to the impeller 80. That is, rotating the shaft 82a rotates the impeller 80.

The shaft 128 is rotated by the sun gear 96 of the geared architecture 48, which is rotated by the shaft 88. The motor 122 is not driving the shaft 82a when the clutch 126 is engaged. When the motor 122 is running, and driving the impeller 80, the clutch 126 disengages such that the shaft 82a is free to be rotated by the electric motor 122 relative to the shaft 128. In FIG. 3, the clutch 126 is shown in a disengaged position, which corresponds to the electric motor 122 driving the impeller 80.

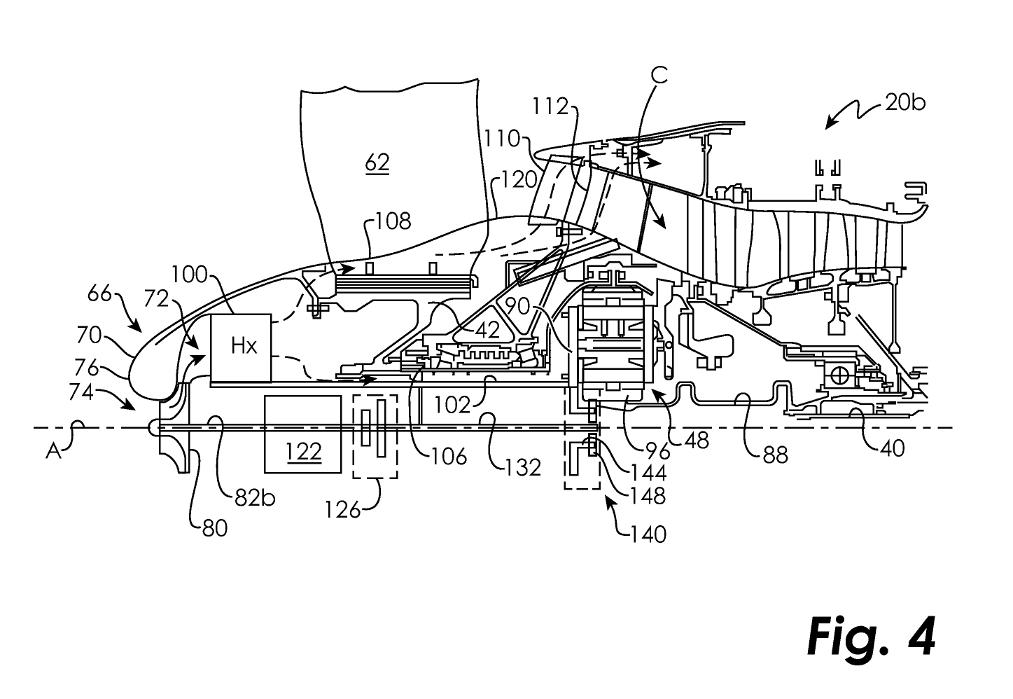

Referring to FIG. 4, in yet another example engine 20b, the impeller is selectively rotated by the motor 122 or the shaft 132, again selected by a clutch 126. However, in this example, a geared architecture 140 is used to alter the rotational speed of the shaft 132 relative to the shaft 88. In this example, the shaft 88 rotates the sun gear 96 to rotate the geared architecture 140. The geared architecture 140, in turn, rotates the shaft 132 which rotates a shaft 82b that rotates the impeller 80 when the clutch 126 is in the engaged position.

In this example, the stationary carrier 90 of the geared architecture 48 includes extensions 144 that support gears 148 of the geared architecture 140. The gears 148 are planetary gears in this example. Rotating the geared architecture 140 rotates the shaft 82 to drive the impeller 80. The geared architecture 140, in this example, has a gear ratio of about five (5 to 1). That is, when the shaft 88 is used to rotate the impeller 80, one rotation of the shaft 88 rotates the shaft 82 (and the impeller 80) five times.

When the impeller 80 is not rotated by the shaft 88, the impeller 80 is driven by the electric motor 122. The clutch 126 controls the selective rotation of the impeller 80 using the electric motor 122 or shaft 88.

Utilizing the geared architecture 140 enables the impeller 80 to rotate at a faster speed than the shaft 88 when the clutch 126 is engaged. In one example, the gear ratio of the geared architecture 140 is about five (5 to 1). That is, one rotation of the shaft 88 rotates the impeller 80 five times.

Features of the disclosed examples include a thermal management strategy that provides increased space within a core engine nacelle. Another feature is providing thermal energy to limit ice formation on various components at a front of an engine without using a dedicated flow of bleed air from other areas of the engine. Yet another feature is increasing Line Replaceable Unit (LRU) capability since the heat exchanger is located in the nose cone. LRU refers to components external to the engine core (pumps, heat exchangers, etc.) that are relatively easy to change out if they become damaged. Still another feature is greater flexibility to adjust nacelle contours around an engine, which provides a potential performance benefit.

Engine heat loads are typically handled via a combination of fuel/oil and air/oil coolers in the prior art. And although heat loads are typically lower at idle and near idle conditions, the associated lower fuel flow rate at these conditions significantly lessens the ability of the fuel/oil coolers to reject heat. The specific features of the embodiments shown in FIGS. 3 and 4, specifically the TMS pump being rotated by a motor or a dedicated gear set at much higher speeds than could be accomplished by directly driving the pump with a turbine shaft, thus compensate for the natural drop-off in heat rejection capability in prior art configurations at idle and near-idle conditions.

Rotating the pump via the planetary gear system as shown in the FIG. 4 embodiments allows the pump to rotate faster than the shaft rotated by the turbine. In this manner the disclosed examples effectively replace three systems (spinner anti-ice, front bearing compartment buffering, and TMS cooling).

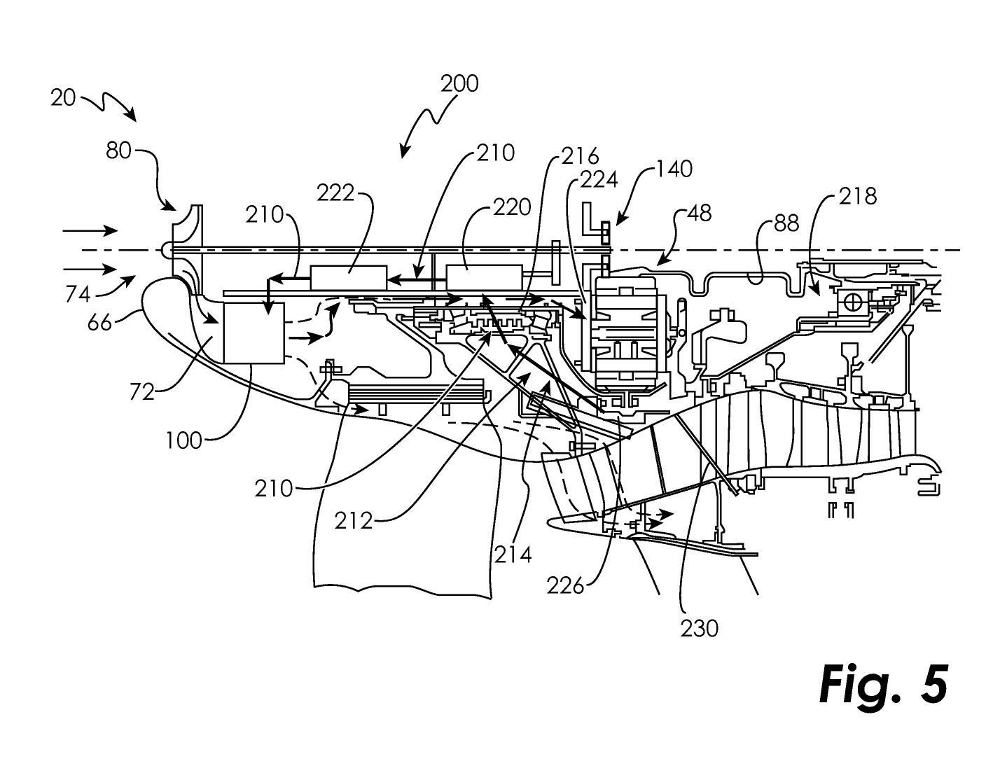

Referring now to FIG. 5, a lubricant circulation system 200 of the gas turbine engine 20 is illustrated. The lubricant circulation system 200 may be incorporated into any of the embodiments of the gas turbine engines 20, 20a, 20b disclosed herein. The lubricant circulation system 200 includes the nose cone 66 having the aperture 74 communicating air to the interior space 72 of the nose cone 66, the heat exchanger 100 disposed in the interior space 72, and a lubricant circulation pathway 210 contained within a forward portion 212 of the gas turbine engine 20. The lubricant circulation pathway 210 is configured to circulate lubricant, such as oil, through the heat exchanger 100. The forward portion 212 includes a front bearing compartment 214 housing a front bearing assembly 216. The front bearing compartment 214 in one or more embodiments may be referred to as the #1 bearing compartment or the forwardmost bearing compartment. The lubricant circulation pathway 210 is configured to circulate lubricant between the front bearing compartment 214 and the heat exchanger 100. The front bearing compartment 214 of one embodiment houses the front bearing assembly 216, the geared architecture 48, and a middle bearing assembly 218 at the forward portion 212 of the engine 20.

The lubricant circulation system 200 of one or more embodiments includes a lubricant pump 220 and a lubricant filter 222 in the lubricant circulation pathway 210. The system 200 of FIG. 5 includes an air pump 80 at least partially disposed within the nose cone 66 and configured to communicate air through the heat exchanger 100. The air pump 80 may include any embodiment described above. The air pump 80 is configured to communicate air around the forward portion 212 of the gas turbine engine 20. The air pump 80 is driven by the shaft 88, including a low shaft, to communicate air through the aperture 74 in one embodiment. The air pump 80 may be driven through the geared architecture 48, including a planetary gear set, coupled to the shaft 88. The ring gear of the geared architecture 48, as shown in FIG. 5, may drive the air pump 80. The geared architecture 140 shown in FIG. 4 may be utilized to drive the air pump 80. The lubricant pump 220 of one embodiment is driven by a rotation of the air pump 80. The air pump 80 or the lubricant pump 220 may be driven by any drive or control means described in the present disclosure.

In the embodiment shown in FIG. 5, the lubricant circulation pathway 210 includes a scavenge line 228 supplying lubricant to the lubricant pump 220. Lubricant is then circulated from the lubricant pump 220 to the lubricant filter 222 before circulating to the heat exchanger 100, where heat is removed from the lubricant, including with the aid of the air pump 80. The filtered and cooled lubricant is then circulated to a lubricant distribution manifold 224 at a forward end of the geared architecture 48. The lubricant distribution manifold 224 delivers lubricant to the geared architecture 48 and bearings 216, 218. The lubricant collects in a lubricant reservoir 226 within the forward portion 212 of the engine 20. In one embodiment, a breather vent 230 is disposed at the forward portion 212 to vent air from the forward portion 212 out of the gas turbine engine 20. The breather vent 230 may also be utilized for adding lubricant to the reservoir 226 during service operations. Although shown on a lower half of the engine 20 in FIG. 5 for illustrative purposes, the vent 230 may be located at an upper half of the engine 20.

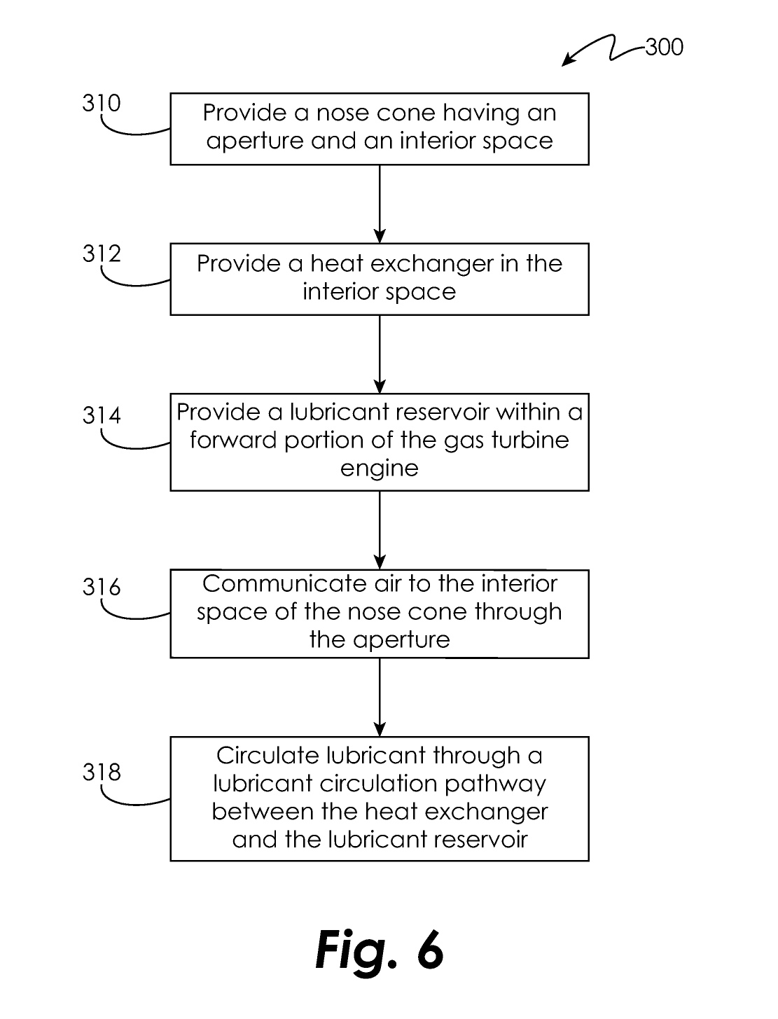

Referring now to FIG. 6, a method 300 of circulating lubricant in the gas turbine engine 20 is disclosed. The method 300 includes providing, at step 310, the nose cone 66 having the aperture 74 and the interior space 74, providing, at step 312, the heat exchanger 100 in the interior space 74, and providing, at step 314, the lubricant reservoir 226 within the forward portion 212 of the gas turbine engine 20. The method 300 further includes communicating, at step 316, air to the interior space 74 of the nose cone 66 through the aperture 74 and circulating, at step 318, lubricant through the lubricant circulation pathway 210 between the heat exchanger 100 and the lubricant reservoir 226.

The method 300 of one or more embodiments further includes circulating lubricant in the lubricant circulation pathway 210 between the front bearing compartment 214 and the heat exchanger 100, pumping lubricant through the lubricant circulation pathway 210 with the lubricant pump 220, or driving the lubricant pump 220 with the shaft 88. The method 300 may further include circulating lubricant through the lubricant filter 222, providing the breather vent 230 at the forward portion 212 of the gas turbine engine 20, or venting air from the forward portion 212 out of the gas turbine engine 20. The method 300 may further include pumping air through the heat exchanger 100 with the air pump 80, pumping air around the forward portion 212 of the gas turbine engine 20 with the air pump 80, or driving the air pump 80 with a shaft 88, such as a low shaft, to communicate air through the aperture. The air pump may be driven through a planetary gear box coupled to the shaft 88. The lubricant pump 220 may be driven by the air pump 80.

The system 200 and method 300 of the present disclosure illustrates a self-contained system and method for pumping, filtering, cooling, distributing, and/or storing lubricant at the forward portion 212 of the engine 20. The system 200 and method 300 greatly improves current engine oil systems by significantly reducing the number of supply conduits and externally mounted filters and coolers and eliminating the need for an oil tank. All servicing may be handled by removing the nose cone and removing the lubrication system components described above from the static structural support.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A lubricant circulation system for a gas turbine engine comprising:
a nose cone having an aperture communicating air to an interior space of the nose cone;
a heat exchanger disposed in the interior space; and
a lubricant circulation pathway contained within a forward portion of the gas turbine engine and configured to circulate lubricant through the heat exchanger.

2. The system of claim 1, further comprising a front bearing compartment at the forward portion of the gas turbine engine, wherein the lubricant circulation pathway is configured to circulate lubricant between the front bearing compartment and the heat exchanger.

3. The system of claim 1, further comprising a lubricant pump in the lubricant circulation pathway.

4. The system of claim 1, further comprising a lubricant filter in the lubricant circulation pathway.

5. The system of claim 1, further comprising an air pump at least partially disposed within the nose cone and configured to communicate air through the heat exchanger.

6. The system of claim 5, wherein the air pump is further configured to communicate air around the forward portion of the gas turbine engine.

7. The system of claim 5, wherein the air pump is driven by a low shaft to communicate air through the aperture.

8. The system of claim 7, wherein the air pump is driven through a planetary gear box coupled to the low shaft.

9. The system of claim 7, further comprising a lubricant pump in the lubricant circulation pathway, wherein the lubricant pump is driven by a rotation of the air pump.

10. A method of circulating lubricant in a gas turbine engine comprising:
providing a nose cone having an aperture and an interior space;
providing a heat exchanger in the interior space;
providing a lubricant reservoir within a forward portion of the gas turbine engine;
communicating air to the interior space of the nose cone through the aperture; and
circulating lubricant through a lubricant circulation pathway between the heat exchanger and the lubricant reservoir.

11. The method of claim 10, further comprising:
providing a front bearing compartment at the forward portion of the gas turbine engine; and
circulating lubricant in the lubricant circulation pathway between the front bearing compartment and the heat exchanger.

12. The method of claim 10, further comprising:
providing a lubricant pump in the lubricant circulation pathway; and
pumping lubricant through the lubricant circulation pathway with the lubricant pump.

13. The method of claim 12, further comprising:
providing a low shaft in the gas turbine engine; and
driving the lubricant pump with the low shaft.

14. The method of claim 10, further comprising:
providing a lubricant filter in the lubricant circulation pathway; and
circulating lubricant through the lubricant filter.

15. The method of claim 10, further comprising:
providing a breather vent at the forward portion of the gas turbine engine; and
venting air from the forward portion out of the gas turbine engine.

16. The method of claim 10, further comprising:
providing an air pump at least partially disposed within the nose cone; and
pumping air through the heat exchanger with the air pump.

17. The method of claim 16, further comprising pumping air around the forward portion of the gas turbine engine with the air pump.

18. The method of claim 16, further comprising driving the air pump with an engine shaft to communicate air through the aperture.

19. The method of claim 18, further comprising driving the air pump through a planetary gear box coupled to the engine shaft.

20. The method of claim 19, further comprising:
providing a lubricant pump in the lubricant circulation pathway; and
driving the lubricant pump with the air pump.
